(19) United States
(12) Patent Application Publication
(10) Pub. No.: US 2023/0053006 A1
(43) Pub. Date: Feb. 16, 2023

(54) Method and System of a Tire Load Sensor

(71) Applicant: Enervibe Ltd., Hevel Eilot (IL)

(72) Inventors: Dan Haronian, Efrat (IL); Michael Haronian, Efrat (IL)

(73) Assignee: Enervibe Ltd., Hevel Eilot (IL)

(21) Appl. No.: 17/523,970

(22) Filed: Nov. 11, 2021

Related U.S. Application Data
(63) Continuation-in-part of application No. 17/399,277, filed on Aug. 11, 2021.

(51) Int. Cl. B60C 23/04; G01L 17/00

(52) U.S. Cl. CPC B60C 23/0411; G01L 17/005; B60C 23/0425

(57) ABSTRACT

A method and system for measuring a load on a tire while the vehicle traveling that include a microprocessor, a tire pressure sensor that is fixed to the tire, and an electromechanical sensor that is fixed to a point on the tire. The electromechanical sensor generates a beginning signal when the point begins to be part of the flat tire contact patch of the tire with the ground, and an ending signal when this point ceases to be part of the patch. The microprocessor calculates the patch contact time period, calculates the flat tire contact patch length from the radius of the tire and the ratio between the patch contact time period and the complete tire rotation period, and calculates the load on the tire from the tire pressure as measured by the pressure sensor and the length of the flat tire contact patch.

### THE TECHNICAL FIELD

The present invention refers to a system and a method of a real time vehicle tire load sensor.

### BACKGROUND OF THE INVENTION AND PRIOR ART

The present invention discloses a system and a method of a real time vehicle tire load sensor. Tire load sensor can be used to evaluate the load on individual tire and the overall load on a vehicle. A tire load sensor can also sense load shifting during driving and to alert from damage to the vehicle or the load and of potential accidents. Such a sensor may also be used to control the tire pressure using Automatic tire inflation systems (ATIS).

Patent EP 2 832 561 B1, describes to a tire load sensing system of a vehicle comprising a distance sensor mounted on the vehicle adjacent to a corresponding tire that provides the distance between the sensor to a surface. Taking account of the tire pressure this information is analyzed to determines the load on the tire.

U.S. Pat. No. 8,096,174 B2 describes a tire load measurement that is computed from the dynamic rolling radius of a tire and the internal air pressure of the tire.

Japanese patent publication, 2005-140503, describes a tire load sensor using a load sensor fixed between a rim and the tire mounted on the rim.

This patent application describes a tire load sensing method that is based on a sensor that is embedded inside the tire and calculates the load on the tire from the pressure inside the tire and from signals received from the sensor.

### BRIEF DESCRIPTION OF THE FIGURES

FIG. 1a describes the tire (1001) and the rim (1002) on the ground (1003).

FIG. 1b describes the time difference dt1 and the full rotation time of the wheel dt2.

FIG. 2 depicts the electromagnetic sensor (1005) with the magnet (100) suspended by the suspending device (2) inside the coil (102).

FIG. 3 depicts another kind of electromagnetic sensor.

FIGS. 4a and 4b depicts a detailed description of the electromagnetic sensor described in FIG. 3.

FIG. 5 is an embodiment of a spring-less electromagnetic sensor.

FIG. 6 is an embodiment of a spring-less electromagnetic sensor with a long lever for high moment generation.

FIG. 7 is another embodiment of a spring-less electromagnetic sensor.

FIG. 8 describes a typical response of an electromagnetic sensor when fixed to the inside of the tire.

FIG. 9 describes an electrical impulse generated by the electromagnetic device as it crosses the tire flat patch.

FIG. 10 describes the electrical impulse generated by the electromagnetic sensor when the axle of the wheel is unloaded and when loaded by a load of 112 kg.

FIG. 11 describes a specific embodiment of the electromechanical sensor (1005A),

FIG. 12 describes an electrical impulse generated by the electromechanical sensor.

### FIELD OF THE INVENTION

This patent application a method for a real time vehicle tire load sensing that is embedded inside the tire. The method comprises a mean to measure the tire patch length, a tire pressure sensor and an analyzer that relates the vehicle velocity, the tire patch length, and the tire pressure to the load on the tire.

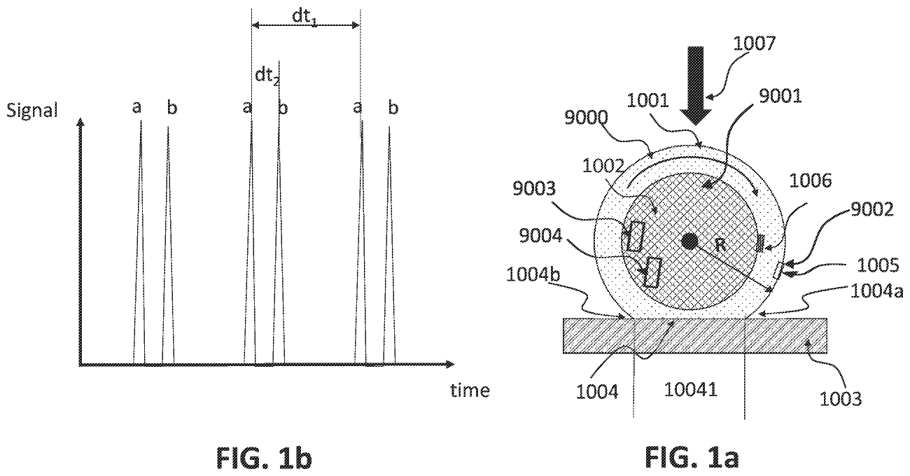

FIG. 1a describes schematically a tire (1001) on a rim (1002) rolling over the ground (1003). The patch is the area (1004) of contact between the tire and the ground. The length of the patch (10041) depends on the tire pressure as measured by a tire pressure sensor (1006) and the load on the tire (1007). The bending of the tire at the two sides of the patch (1004a and 1004b) is a source of mechanical impulse and therefore an electromechanical device (1005) that is designed to be sensitive to mechanical impulse may be used to signal these two points. This is described schematically in FIG. 1b. The time difference dt₁ is the time it takes for the wheel to complete a full rotation and dt₂ is the time it takes for the electromechanical device to cross the patch from point 1004a to point 1004b. Therefore, assuming the circumference of the tire is Lₜ the velocity of the vehicle is V=Lₜ/dt₁. In such case the patch length Lₚ=Vdt₂=Lₜdt₂/dt₁=2πRdt₂/dt₁—where R is the radius of the tire. The load on the tire depends on the patch length and on the tire pressure. This can be calculated using for example an empirical equation or using a lookup table.

This patent application describes different means of electromechanical sensors (1005), such as electromagnetic and piezoelectric, as examples for such electromechanical sensors.

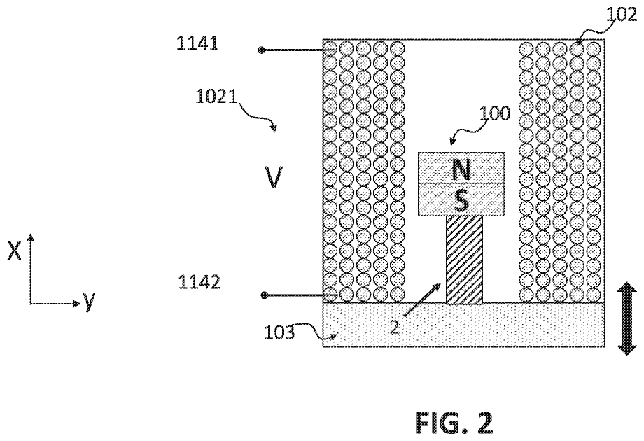

FIG. 2 describes an Electromagnetic device showing a magnet (100) suspended by a suspending device (2) inside a coil (102). The coil is fixed to a body (103) such that when subject to shocks such as the shocks generated at the two sides of the patch of the tire, the magnet moves or vibrates relative to the coil and induces voltage between the two ends of the coil (1021). It is noted that the magnet with the suspending device may be located outside of the coil.

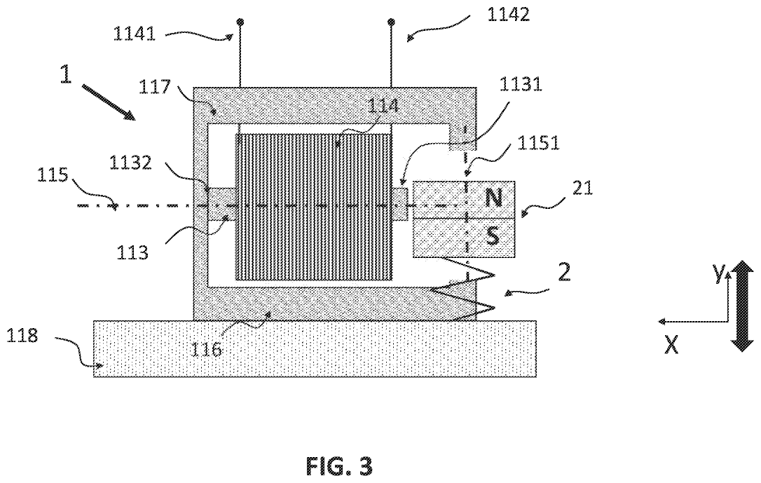

FIG. 3 shows another Electromagnetic device. Here magnet (21) suspended by a suspending device (2) such as a spring. The magnet is free to move or vibrate vertically (1151) to the length of the core (115). Device (1) is fixed to the body (118) and comprise a ferromagnetic core (113) winded by coil (114). The magnet is close to a first side (1131) of the coil such that when subject to shocks such as the shocks generated at the two sides of the patch of the tire, a movement or an oscillating movement of the magnet relative to the first side of the core is induced such that a voltage or an alternating voltage is generated between the two ends (1141) and (1142) of the coil. Device (1) may also include ferromagnetic magnetic flux confiners (116) and (117) that confines the magnetic flux close to the coil.

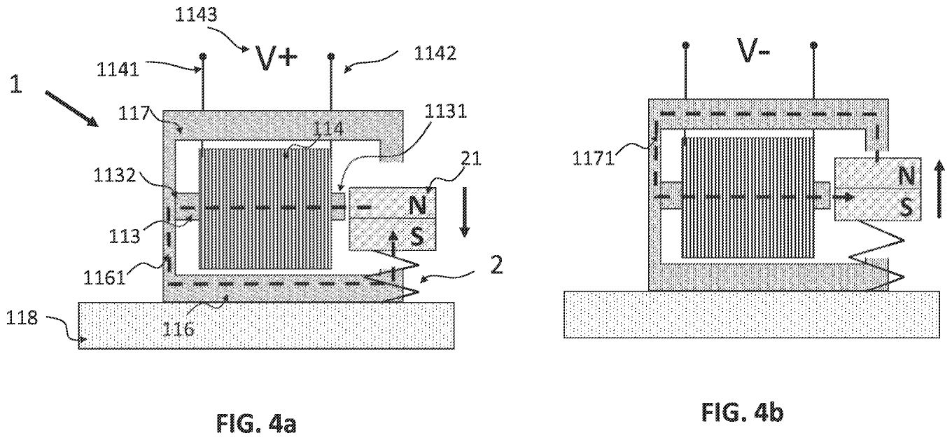

FIGS. 4a and 4b describe the operation of the sensor in more details. In FIG. 4a the magnet (21) moves downwards and changes the magnetic polarity of the magnetic flux in the core such that the magnetic flux (1161) flows through the lower magnetic flux confiner (116). In FIG. 4b, the magnet moves upwards reversing the magnetic polarity of the magnetic flux in the core such that the magnetic flux (1171) flows through the upper magnetic flux confiner (117). These rapid polarity changes of the magnetic flux lead to high dΦ/dt and to an alternating voltage (1143) between the coil ends (1141, 1142).

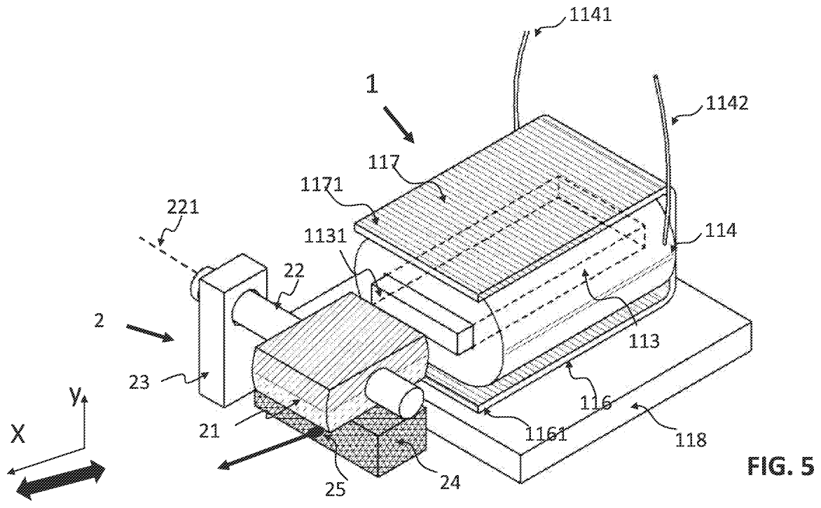

FIG. 5 describes an embodiment of a spring-less electromagnetic device. As in previous embodiments, the sensor comprise a device (1) fixed to a support (118). The suspending device (2) comprises a hinge (22), supported by support (23) that is fixed to the body (118), is free to rotate around its axis (221). The magnet (21) and a seismic mass (24) are fixed to the hinge such that the weight of the hinge, loaded by the seismic mass and the magnet, shifts the center of gravely (25) off from the hinge rotation axis (221). The magnet is positioned close to one side of the core (1131) and to the ends of the bottom and upper magnetic flux confiner (1161, 1171) such that it is approximately aligned to the core. Upon a shock on the body in the X direction, and due to the location of the center of gravity (25) off the center of rotation, a relative movement or alternating movement is induced between the core and the magnet that induce an intensity change or an oscillating intensity change of magnetic flux along the core and along the magnetic flux confiners that induces an alternating voltage between the coil ends (1141, 1142). It is noted that the sensor is designed such that there is one stable state of the magnet, such that at rest the magnet is approximately aligned with the core.

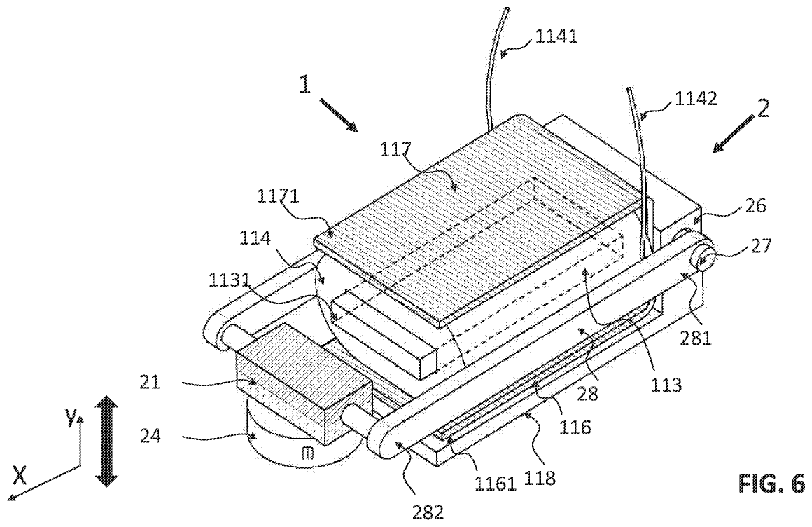

FIG. 6 describes another embodiment of a spring-less electromagnetic device. As in previous embodiments the device comprise a device (1) fixed to a support (118). Suspending device (2) comprise a support (26) fixed to the body (118) and a free to rotate hinge (27). The free to rotate hinge is fixed to one end (281) of a lever (28) and the second end of the lever is fixed to the magnet (21) and to a seismic mass (24). The magnet is positioned close to the end of the core (1131) and to the ends of the bottom and upper magnetic confiner (1171, 1161) such that it is held approximately aligned to the core. Upon impact in the Y direction on the body, a relative displacement or an oscillating relative displacement is induced between the end of the core (1131) and the magnet (21), that induces a voltage or an alternating voltage between the coil ends (1141, 1142).

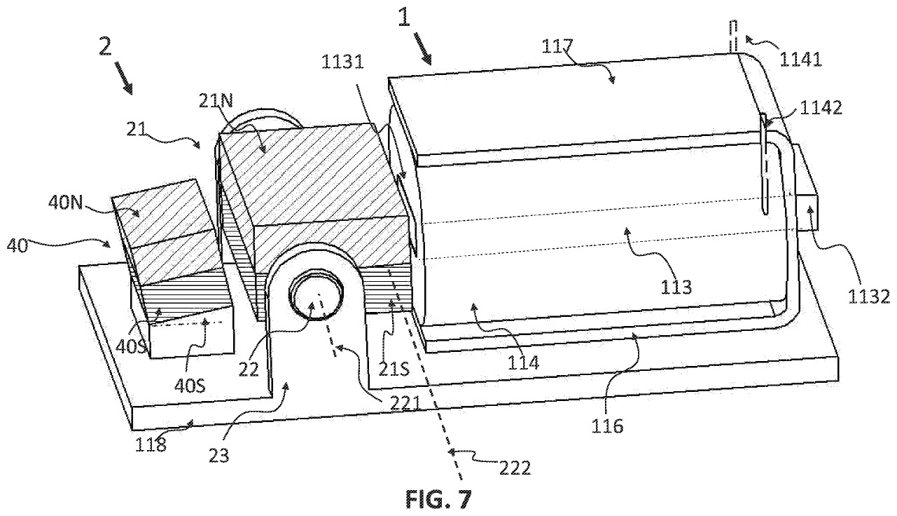

FIG. 7 describes another embodiment of a spring-less sensor. In this embodiment suspending device (2) comprising a free to rotate hinge (22) that is supported by a base (118) that is connected to the body. Magnet (21) is fixed to the hinge and therefore may rotate around the axis of the hinge. Suspending device (2) further includes a stationary magnet (40) that is attached to the body or to the base at a pre-designed angle (41) and at close proximity to the free to rotate magnet (21) such that the similar poles (40N) and (21N) as well as (40S) and (21S) are facing each other and such that magnet (21) is facing the end of the core (1131) at a pre-designed position. The center of gravity (222) of the hinge and the free to rotate magnet, is shifted off the rotation axis (221) of the hinge such that shocks applied on the body can cause the magnet to rotate. The stationary magnet serves as a restoring force to magnet (21) when forced off its rest position such that a shock applied on the body may cause an alternating relative movement between the core (113) and the free to rotate magnet (21) that can create a voltage or an alternating voltage between said ends of said coil ends (1141, 1142).

The pre-determined angle (41) as well as the position of magnet (21) relative to the end of the core (1131) depends on the shape and direction of the exciting force.

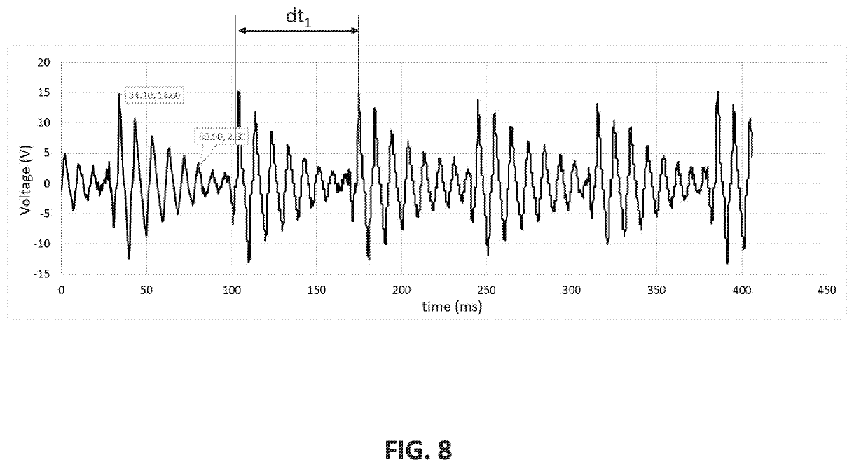

FIG. 8 describes a typical response of an electromagnetic device described in this patent application when fixed to the inside of the tire. Each oscillating electrical signal is generated by the electromagnetic device as it crosses the tire flat patch. The time difference between two adjacent signals is the time it takes for the wheel to complete one rotate and is noted by dt₁ in FIG. 1. Each signal generates a decaying relative oscillations of the magnet relative to the core or to the coil that generates a decaying alternating voltage between the wires winded around the core. With respect to the spring-less Electromagnetic device described in this patent application, the oscillation depicts a spring-mass like behavior of the magnet-core-seismic mass system.

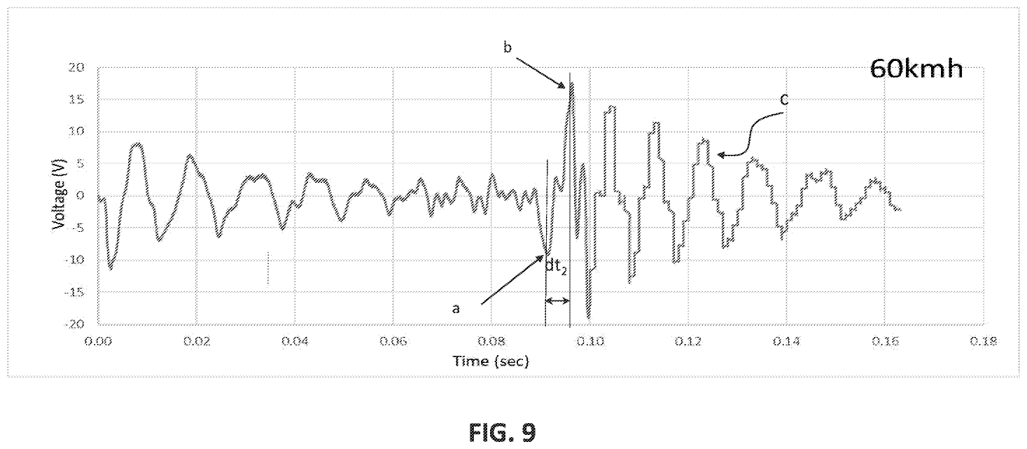

FIG. 9 describes a single electrical signal generated by the electromagnetic device. The response of the sensor at the entrance to the patch is represented by point “a” and the response of the sensor at the exit from the patch is represented by point “b”. The decaying oscillation of the magnet vibrations is represented by the decaying signal “c” that take place during the rotation of the tire until it reaches point “a” again. A fast responding sensor with higher resonance frequency will have additional oscillations while the sensor crosses the patch.

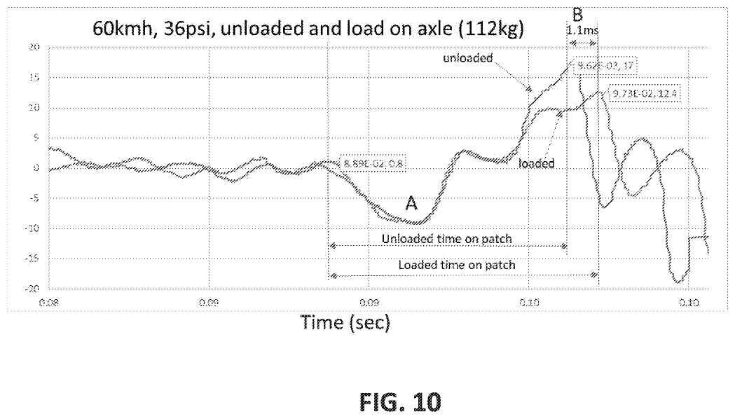

FIG. 10 describes the electrical signal generated by the electromagnetic device when the axle of the wheel is unloaded and when loaded by a load of 112 kg. Since there are two tires on the two sides of the axle this load translates to 56 kg on each tire. The tire pressure in this test is 36 psi. The time difference between the un-loaded and loaded is 1.1 ms, representing a load of 56 kg. The tire rating is 94 with maximum load of 670 kg and therefore the time difference of 1.1 ms at velocity of 60 kmh corresponds to 8.4% of the maximum load.

It is noted that the change in a patch length (10041) can be evaluated using other sensors that are embedded inside the tire such as piezoelectric sensors.

In summary, the present invention discloses a method for measuring a load (1007) on a tire (1001) of a wheel (9000) that is mounted on a vehicle (9001) (only the wheel of the vehicle is shown in the drawings) while the vehicle is traveling. The method comprises the following steps and elements:

Providing a tire pressure sensor (1006) that is designed to be fixed to the tire or to the rim (1002) of the wheel, and fixing the tire pressure sensor to the tire or to the rim; Providing an electromechanical sensor (1005) that is designed to be fixed to the tire, and fixing the electromechanical sensor to the tire; wherein said electromechanical sensor is designed to generate a beginning signal when a point (9002) on the tire to which the electromechanical sensor is fixed begins to be part of a flat tire contact patch (1004) of the tire that is in contact with the ground (1003) while the vehicle is traveling, and is also designed to generate an ending signal when said point ceases to be part of the flat tire contact patch:

Providing a microprocessor (9003) that is designed to calculate a patch contact time period (dt2) that lasts from the beginning signal generation until the ending signal generation.

Calculating by the microprocessor a flat tire contact patch length based on the patch contact time period together with a speed of the vehicle or together with a radius of the tire and a complete tire rotation period that can be calculated by the microprocessor from time differences between beginning signals or between ending signals or that can be calculated by a sensor for measuring tire rotation period. In such case, the microprocessor can calculate a complete tire rotation period (dt1) from time differences between beginning signals or between ending signals, or by a sensor for measuring tire rotation period (9004);

Calculating by the microprocessor a flat tire contact patch length (10041) based on a radius of the tire, the patch contact time period and the complete tire rotation period; and calculating by the microprocessor the load on the tire based on a tire pressure as measured by the pressure sensor and on the length of the flat tire contact patch.

Moreover, the present invention also discloses a system for measuring the load (1007) on the tire (1001) of the wheel that is mounted on the vehicle while the vehicle is traveling, comprising:

The tire pressure sensor (1006) that is designed to be fixed to the tire or to the rim (1002) of the wheel;

The electromechanical sensor (1005) that is designed to be fixed to the tire, wherein said electromechanical sensor is designed to generate a beginning signal when the point on the tire to which the electromechanical sensor is fixed begins to be part of the flat tire contact patch (1004) of the tire that is in contact with the ground while the vehicle is traveling, and is also designed to generate the ending signal when said point ceases to be part of the flat tire contact patch:

The microprocessor is designed to calculate a flat tire contact patch length based on the patch contact time period together with the speed of the vehicle or together with a radius of the tire and a complete tire rotation period that can be calculated by the microprocessor from time differences between beginning signals or between ending signals or that can be calculated by a sensor for measuring tire rotation period. The microprocessor that is designed to calculate the patch contact time period (dt2) that lasts from the beginning signal generation until the ending signal generation; wherein the complete tire rotation period (dt1) can be calculated by the microprocessor based on time differences between beginning signals or between ending signals, or by the sensor for measuring tire rotation period;

wherein said microprocessor is designed to calculate the flat tire contact patch length based on the radius of the tire, the patch contact time period and the complete tire rotation period; and wherein the microprocessor can calculate the load on the tire from the tire pressure as measured by the pressure sensor and the length of the flat tire contact patch.

It is possible to implement the invention in a way that the computers of the vehicle itself or a dedicated processor that is located outside the wheel may serve as the processor and in such case it is preferably to get the speed information from the vehicle computers for doing said calculations. Alternatively, it is possible to employ a dedicated processor inside the wheel and in such case it is preferably to do said calculations based on the complete tire rotation period that can be calculated by the processor and based on the radius that can be stored in the processor.

The electromechanical sensor may comprises a coil (102) and a magnet (100) suspended by a suspending device (2) such that a mechanical shock can cause a 225 relative movement or alternating movement between the magnet and the coil and to generate a voltage or alternating voltage between the ends (1141, 1142) of the coil.

The electromechanical sensor may further include a core (113) on which said coil (114) is winded, and such that said magnet is free to move or vibrate relative to the core.

The suspending device may be a spring.

The electromechanical sensor may further include a core (113) on which said coil (114) is winded, and wherein said suspending device (2) comprises a base (118) that is designed to be connected to the tire (1001) and a free to rotate hinge (22) that is supported by the base and is designed to be connected to said magnet (21), wherein said suspending device further includes a seismic mass (24) that is attached to the hinge and to the magnet, wherein a center of gravity (25) of said hinge, magnet and seismic mass can be shifted off a rotation axis of the hinge such that a mechanical shock can cause a relative movement or an alternating relative movement between the core and the magnet that can create said voltage or alternating voltage between said ends of said coil (1141, 1142).

The electromechanical sensor may further include a core (113) on which said coil (114) is winded, and wherein said suspending device (2) comprises a base (118) that is designed to be connected to the tire (1001) and a free to rotate hinge (27) that is supported by the base, wherein the electromechanical sensor further includes a lever (28) with a first end (281) that is fixed to the hinge (27) and a second end (282) that is fixed to a seismic mass and to said magnet such that a mechanical shock can cause a relative movement or alternating relative movement between the core and the magnet that can create said voltage or alternating voltage between the ends of the coil. The electromechanical sensor may further include a core (113) on which said coil (114) is winded, and wherein said suspending device (2) comprises a base (118) that is designed to be connected to the tire (1001) and to a free to rotate hinge (22) that is supported by the base and is designed to be connected to said magnet (21); wherein a center of gravity (215) of the hinge together with the magnet can be shifted off a rotation axis of the hinge such that a mechanical shock can cause a relative movement or an alternating relative movement between the core and the magnet that can create said voltage or alternating voltage between said ends of said coil; wherein said suspending device (2) further includes a stationary magnet (40) that is attached to the tire or to the base at close proximity to said magnet (21) such that the positive pole of the stationary magnet faces a positive pole of the magnet so that a magnetic force between the two magnets can serve as a restoring force on the magnet.

The stationary magnet may be attached to the tire or to the base at a pre-designed angle.

The electromechanical sensor may be a piezoelectric material sandwich between two electrodes that is designed to be fixed to the tire wherein bending of the piezoelectric material can generate electrical potential between the two electrodes.

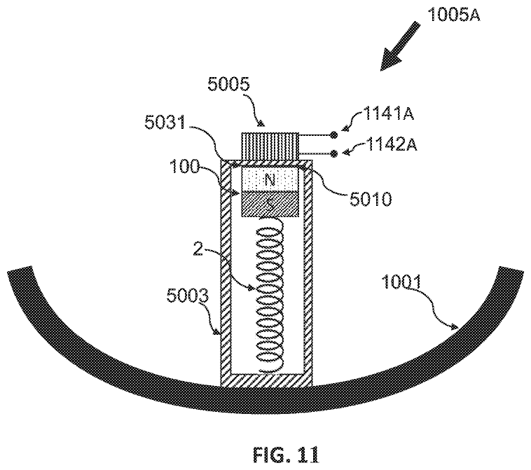

FIG. 11 describes another embodiment of the electromechanical sensor (1005A), which in this embodiment, comprises a magnet (100) that is suspended by a suspending device (2), such as a spring, which is positioned inside a house (5003). The house (5003) is designed to be fixed to the tire (1001), and a magnetic sensor, that can be, for example, a coil or a Hall Effect sensor (5005) that is positioned close to the magnet.

The electromechanical sensor is designed in such a way that a distance (5010) between the magnet and the magnetic sensor become smaller when the point on the tire to which the electromechanical sensor is fixed begins to be part of the flat tire contact patch of the tire that is in contact with the ground while the vehicle is traveling, and this is happened due to the change in the centrifugal intensity force that is acting on the magnet and the change in that distance generates the beginning signal. The electromechanical sensor generates the ending signal when that point ceases to be part of the flat tire contact patch, due to the fact that now again the centrifugal force increases that distance (5010) between the magnet and the magnetic sensor that causes a change in the signal between the output ports (1141A) and (1142A) of the magnetic senor. At the rest condition, while the electromechanical sensor in that flat patch, the magnet can be in position (5031).

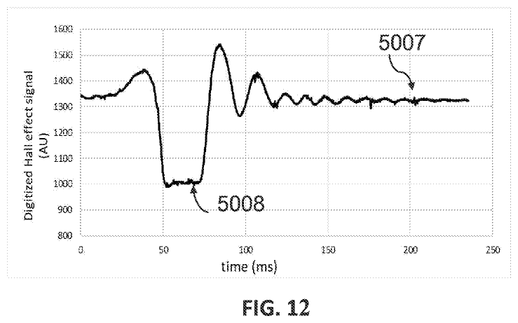

FIG. 12 depicts the response of the electromechanical sensor (1005A) to rotation of the tire. When the electromechanical sensor does not face the ground (the flat patch), a centrifugal force pushes the magnet (100) away from position (5031) and the reading of the magnetic sensor is high (5007). When the electromagnetic sensor faces the ground the centrifugal force is zero and the spring (2) relaxes and pushes the magnet to its rest position (5031) and the reading of the magnetic sensor is low (5008). The width of the patch can be calculated from the time the magnet is at its rest position (5031) and the tire rotation speed as discussed elsewhere in this disclosure.

As described above, the load on the tire can be calculated from the pressure as measured by pressure sensor (1006) and the patch width (10041) which as explain above can be calculated from the time the magnet is at rest position and the tire rotation speed. The width of the patch may also depend on other factor such as temperature, tire aging that may also be added to the calculation of the load.

What is claimed is:

1. A method for measuring a load on a tire of a wheel that is mounted on a vehicle while the vehicle is traveling, comprising:
providing a tire pressure sensor that is designed to be fixed to the tire or to a rim of the wheel, and fixing the tire pressure sensor to the tire or to the rim;
providing an electromechanical sensor that is designed to be fixed to the tire, and fixing the electromechanical sensor to the tire; wherein said electromechanical sensor is designed to generate a beginning signal when a point on the tire to which the electromechanical sensor is fixed begins to be part of a flat tire contact patch of the tire that is in contact with the ground while the vehicle is traveling, and is also designed to generate an ending signal when said point ceases to be part of the flat tire contact patch;
providing a microprocessor that is designed to calculate a patch contact time period that lasts from the beginning signal generation until the ending signal generation;
calculating by the microprocessor a flat tire contact patch length based on the patch contact time period together with a speed of the vehicle or together with a radius of the tire and a complete tire rotation period that can be calculated by the microprocessor from time differences between beginning signals or between ending signals or that can be calculated by a sensor for measuring tire rotation period; and
calculating by the microprocessor the load on the tire based on a tire pressure as measured by the pressure sensor and on the length of the flat tire contact patch.

2. The method for measuring a load on a tire of a wheel that is mounted on a vehicle while the vehicle is traveling according to claim 1, wherein said electromechanical sensor comprises a coil and a magnet suspended by a suspending device such that a mechanical shock can cause a relative movement or an alternating movement between the magnet and the coil and to generate a voltage or an alternating voltage between ends of said coil.

3. The method for measuring a load on a tire of a wheel that is mounted on a vehicle while the vehicle is traveling according to claim 2, wherein said electromechanical sensor further includes a core on which said coil is winded, and such that said magnet is free to move or vibrate relative to the core.

4. The method for measuring a load on a tire of a wheel that is mounted on a vehicle while the vehicle is traveling according to claim 3, wherein said suspending device is a spring.

5. The method for measuring a load on a tire of a wheel that is mounted on a vehicle while the vehicle is traveling according to claim 2, wherein said electromechanical sensor further includes a core on which said coil is winded, and wherein said suspending device comprises a base that is designed to be connected to the tire and a free to rotate hinge that is supported by the base and is designed to be connected to said magnet; wherein said suspending device further includes a seismic mass that is attached to the hinge and to the magnet, wherein a center of gravity of said hinge, magnet and seismic mass can be shifted off a rotation axis of the hinge such that a mechanical shock can cause a relative movement or an alternating relative movement between the core and the magnet that can create said voltage or alternating voltage between said ends of said coil.

6. The method for measuring a load on a tire of a wheel that is mounted on a vehicle while the vehicle is traveling according to claim 2, wherein said electromechanical sensor further includes a core on which said coil is winded, and wherein said suspending device comprises a base that is designed to be connected to the tire and a free to rotate hinge that is supported by the base; wherein the electromechanical sensor further includes a lever with a first end that is fixed to the hinge and a second end that is fixed to a seismic mass and to said magnet such that a mechanical shock can cause a relative movement or an alternating relative movement between the core and the magnet that can create said voltage or altemating voltage between said ends of said coil.

7. The method for measuring a load on a tire of a wheel that is mounted on a vehicle while the vehicle is traveling according to claim 2, wherein said electromechanical sensor further includes a core on which said coil is winded, and wherein said suspending device comprises a base that is designed to be connected to the tire and to a free to rotate hinge that is supported by the base and is designed to be connected to said magnet; wherein a center of gravity of the hinge together with the magnet can be shifted off a rotation axis of the hinge such that a mechanical shock can cause a relative movement or an alternating relative movement between the core and the magnet that can create said voltage or alternating voltage between said ends of said coil; wherein said suspending device further includes a stationary magnet that is attached to the tire or to the base at close proximity to said magnet such that a positive pole of the stationary magnet faces a positive pole of the magnet so that a magnetic force between the two magnets can serve as a restoring force on the magnet.

8. The method for measuring a load on a tire of a wheel that is mounted on a vehicle while the vehicle is traveling according to claim 7, wherein said stationary magnet is attached to the tire or to the base at a pre-designed angle relative to said magnet.

9. The method for measuring a load on a tire of a wheel that is mounted on a vehicle while the vehicle is traveling according to claim 1, wherein said electromechanical sensor is a piezoelectric material sandwich between two electrodes that is designed to be fixed to the tire wherein bending of the piezoelectric material can generate electrical potential between the two electrodes.

10. The method for measuring a load on a tire of a wheel that is mounted on a vehicle while the vehicle is traveling according to claim 1, wherein said electromechanical sensor comprises a magnet suspended by a suspending device that is positioned inside a house that is designed to be fixed to the tire, and a magnetic sensor that is positioned close to the magnet:
wherein the electromechanical sensor is designed in such a way that a distance between the magnet and the magnetic sensor become smaller when said point on the tire to which the electromechanical sensor is fixed begins to be part of said flat tire contact patch of the tire that is in contact with the ground while the vehicle is traveling due to a change in centrifugal force intensity acting on the magnet that generates said beginning signal; and wherein the electromechanical sensor is further designed to generate said ending signal when said point ceases to be part of the flat tire contact patch.

11. A system for measuring a load on a tire of a wheel that is mounted on a vehicle while the vehicle is traveling, comprising:
a tire pressure sensor that is designed to be fixed to the tire or to a rim of the wheel;
an electromechanical sensor that is designed to be fixed to the tire, wherein said electromechanical sensor is designed to generate a beginning signal when a point on the tire to which the electromechanical sensor is fixed begins to be part of a flat tire contact patch of the tire that is in contact with the ground while the vehicle is traveling, and is also designed to generate an ending signal when said point ceases to be part of the flat tire contact patch;
a microprocessor that is designed to calculate a patch contact time period that lasts from the beginning signal generation until the ending signal generation;
wherein said microprocessor is designed to calculate a flat tire contact patch length based on the patch contact time period together with the speed of the vehicle or together with a radius of the tire and a complete tire rotation period that can be calculated by the microprocessor from time differences between beginning signals or between ending signals or that can be calculated by a sensor for measuring tire rotation period; and wherein the microprocessor is designed to calculate the load on the tire from a tire pressure as measured by the pressure sensor and the length of the flat tire contact patch.

12. The system for measuring a load on a tire of a wheel that is mounted on a vehicle while the vehicle is traveling according to claim 11, wherein said electromechanical sensor comprises a coil and a magnet suspended by a suspending device such that a mechanical shock can cause a relative movement or an alternating relative movement between the magnet and the coil and to generate a voltage or an alternating voltage between ends of said coil.

13. The system for measuring a load on a tire of a wheel that is mounted on a vehicle while the vehicle is traveling according to claim 12, wherein said electromechanical sensor further includes a core on which said coil is winded, and such that said magnet is free to move or vibrate relative to the core.

14. The system for measuring a load on a tire of a wheel that is mounted on a vehicle while the vehicle is traveling according to claim 13, wherein said suspending device is a spring.

15. The system for measuring a load on a tire of a wheel that is mounted on a vehicle while the vehicle is traveling according to claim 12, wherein said electromechanical sensor further includes a core on which said coil is winded, and wherein said suspending device comprises a base that is designed to be connected to the tire and a free to rotate hinge that is supported by the base and is designed to be connected to said magnet; wherein said suspending device further includes a seismic mass that is attached to the hinge and to the magnet, wherein a center of gravity of said hinge, magnet and seismic mass can be shifted off a rotation axis of the hinge such that a mechanical shock can cause a relative movement or an alternating relative movement between the core and the magnet that can create said voltage or alternating voltage between said ends of said coil.

16. The system for measuring a load on a tire of a wheel that is mounted on a vehicle while the vehicle is traveling according to claim 12, wherein said electromechanical sensor further includes a core on which said coil is winded, and wherein said suspending device comprises a base that is designed to be connected to the tire and a free to rotate hinge that is supported by the base; wherein the electromechanical sensor further includes a lever with a first end that is fixed to the hinge and a second end that is fixed to a seismic mass and to said magnet such that a mechanical shock can cause a relative movement or an alternating relative movement between the core and the magnet that can create said voltage or alternating voltage between said ends of said coil.

17. The system for measuring a load on a tire of a wheel that is mounted on a vehicle while the vehicle is traveling according to claim 12, wherein said electromechanical sensor further includes a core on which said coil is winded, and wherein said suspending device comprises a base that is designed to be connected to the tire and a free to rotate hinge that is supported by the base and is designed to be connected to said magnet; wherein a center of gravity of the hinge together with the magnet can be shifted off a rotation axis of the hinge such that a mechanical shock can cause a relative movement or an alternating relative movement between the core and the magnet that can create said alternating voltage between said ends of said coil; wherein said suspending device further includes a stationary magnet that is attached to the tire or to the base at close proximity to said magnet such that a positive pole of the stationary magnet faces a positive pole of the magnet so that a magnetic force between the two magnets can serve as a restoring force on the magnet.

18. The system for measuring a load on a tire of a wheel that is mounted on a vehicle while the vehicle is traveling according to claim 12, wherein said stationary magnet is attached to the tire or to the base at a pre-designed angle relative to the magnet.

19. The system for measuring a load on a tire of a wheel that is mounted on a vehicle while the vehicle is traveling according to claim 11, wherein said electromechanical sensor is a piezoelectric material sandwich between two electrodes that is designed to be fixed to the tire wherein bending of the piezoelectric material can generate electrical potential between the two electrodes.

12. The system for measuring a load on a tire of a wheel that is mounted on a vehicle while the vehicle is traveling according to claim 11, wherein said electromechanical sensor comprises a coil and a magnet suspended by a suspending device such that a mechanical shock can cause a relative movement or an alternating relative movement between the magnet and the coil and to generate a voltage or an alternating voltage between ends of said coil.

20. The system for measuring a load on a tire of a wheel that is mounted on a vehicle while the vehicle is traveling according to claim 11, wherein said electromechanical sensor comprises a magnet suspended by a suspending device that is positioned inside a house that is designed to be fixed to the tire, and a magnetic sensor that is positioned close to the magnet;
wherein the electromechanical sensor is designed in such a way that a distance between the magnet and the magnetic sensor become smaller when said point on the tire to which the electromechanical sensor is fixed begins to be part of said flat tire contact patch of the tire that is in contact with the ground while the vehicle is traveling due to a change in centrifugal force intensity acting on the magnet that generates said beginning signal; and wherein the electromechanical sensor is further designed to generate said ending signal when said point ceases to be part of the flat tire contact patch.
